(19) United States
(12) Patent Application Publication
(10) Pub. No.: US 2014/0207998 A1
(43) Pub. Date: Jul. 24, 2014

(54) SYSTEM AND METHOD OF WEAR LEVELING FOR A NON-VOLATILE MEMORY

(71) Applicant: SKYMEDI CORPORATION, Hsinchu City (TW)

(72) Inventors: JiunHsien Lu, Hsinchu City (TW); Yi Chun Liu, Hsinchu City (TW)

(73) Assignee: SKYMEDI CORPORATION, Hsinchu City (TW)

(21) Appl. No.: 13/746,234

(22) Filed: Jan. 21, 2013

(51) Int. Cl. G06F 12/02

(52) U.S. Cl. CPC G06F 12/0246
USPC 711/103

(57) ABSTRACT

In an architecture of wear leveling for a non-volatile memory composed of plural storage units, a translation layer is configured to translate a logical address provided by a host to a physical address of the non-volatile memory. A cold-block table is configured to assign a cold block or blocks in at least one storage unit, the cold block in a given storage unit having an erase count being less than erase counts of non-cold blocks in the given storage unit. The logical addresses and the associated physical addresses of the cold blocks are recorded in the cold-block table, thereby building a cold-block pool composed of the cold blocks.

### BACKGROUND OF THE INVENTION

1. Field of the Invention

The present invention generally relates to wear leveling, and more particularly to a hierarchical architecture of global wear leveling for a non-volatile memory with multiple storage units.

2. Description of Related Art

Some erasable storage media such as flash memory devices may become unreliable after being subject to a limited number of erase cycles. The lifetime of these erasable storage media may be severely reduced when the erase cycles are substantially concentrated in fixed data blocks, while most remaining data blocks are devoid of erase cycles. FIG. 1 shows a conventional storage device such as a flash memory composed of four storage units (i.e., unit 1 to unit 4) representing, for example, four planes, channels or chips, respectively. Incoming data are written to the unit 1 through the unit 4 according to remainders by subjecting logical block address (LBA) to modulo (mod) operation. As shown in FIG. 1, data with remainder within {0, . . . , 15} are written to the unit 1, data with remainder within {16, . . . 31} are written to the unit 2, and so forth. More often than not, data may probably be written to a specific one (e.g., the unit 1) of the four storage units most of the time. As mentioned above, the lifetime of the storage device of FIG. 1 may thus be seriously shortened. In order to extend the service life of the storage device, a few schemes of wear leveling have been devised to ensure the erase cycles are evenly distributed. However, conventional wear leveling mechanisms are either affecting only a restricted portion of the storage device or requiring complex algorithm.

For the foregoing reasons, a need has thus arisen to propose a novel scheme to enhance wear leveling for storage devices, particularly a non-volatile memory with multiple storage units.

### SUMMARY OF THE INVENTION

In view of the foregoing, it is an object of the embodiment of the present invention to provide a hierarchical architecture of global wear leveling for a non-volatile memory, particularly with multiple storage units, to globally and preemptively enhance wear leveling in the non-volatile memory.

According to one embodiment, the non-volatile memory includes a plurality of storage units. A translation layer is configured to translate a logical address provided by a host to a physical address of the non-volatile memory. A cold-block table is configured to assign a cold block or blocks in at least one said storage unit, the cold block in a given storage unit having an erase count being less than erase counts of non-cold blocks in the given storage unit. The logical addresses and the associated physical addresses of the cold blocks are recorded in the cold-block table, thereby building a cold-block pool composed of the cold blocks.

### BRIEF DESCRIPTION OF THE DRAWINGS

FIG. 1 shows a conventional storage device composed of four storage units;

FIG. 2 shows a hierarchical architecture of global wear leveling for a non-volatile memory according to one embodiment of the present invention;

FIG. 3 shows an exemplary non-volatile memory of FIG. 2;

FIG. 4A and FIG. 4B show an example of sequentially assigning a cold block in a memory composed of two storage units;

FIG. 5A through FIG. 5C show another example of sequentially assigning six cold blocks in a memory composed of four storage units;

FIG. 6 shows a flow diagram of reading data from the memory to the host according to the embodiment of the present invention; and

FIG. 7 shows a flow diagram of writing data from the host to the memory according to the embodiment of the present invention.

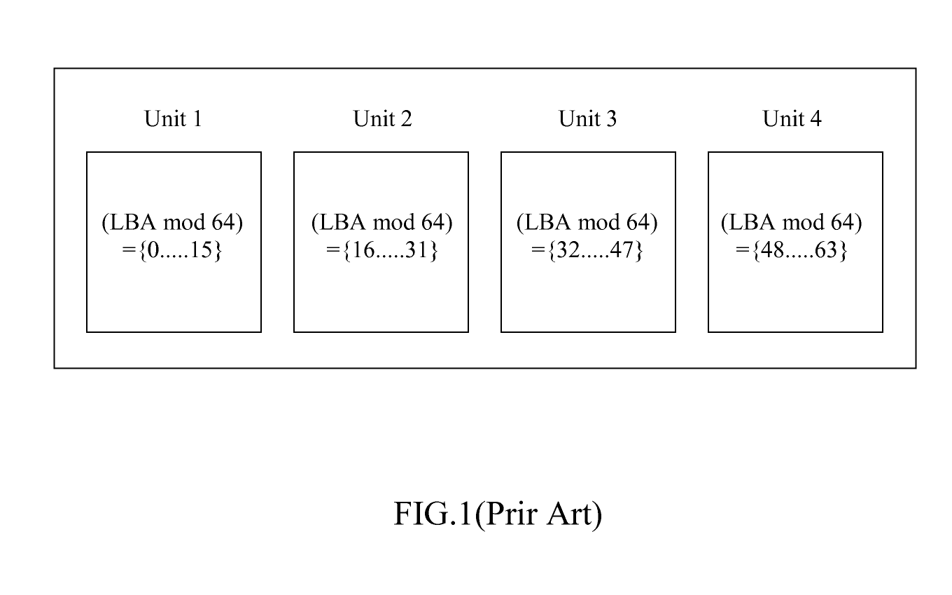

### DETAILED DESCRIPTION OF THE INVENTION

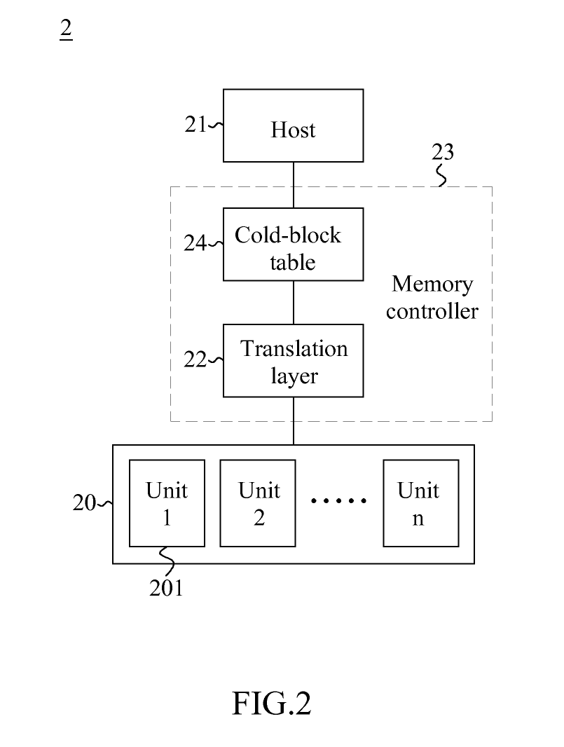

FIG. 2 shows a hierarchical architecture 2 of global wear leveling for a non-volatile memory 20 accessible by a host 21 (e.g., a computer) according to one embodiment of the present invention. The non-volatile memory (abbreviated as memory hereinafter) 20 may be, but is not limited to, a flash memory. The memory 20 of the embodiment includes multiple storage units 201 such as unit 1, unit 2, etc. as shown. The memory 20 composed of storage units 201 may be partitioned according to a variety of parallelisms such as plane-level parallelism, channel-level parallelism, die (chip)-level parallelism or their combination.

In a memory controller 23 disposed between the host 21 and the memory 20, a translation layer 22 is used to translate a logical address e.g., a logical block address or LBA) provided by the host 21 to a physical address of the memory 20, under control of the memory controller 23. The translation layer 22 of the embodiment may be, for example, a flash translation layer (FTL) for supporting normal file systems with a flash memory 20.

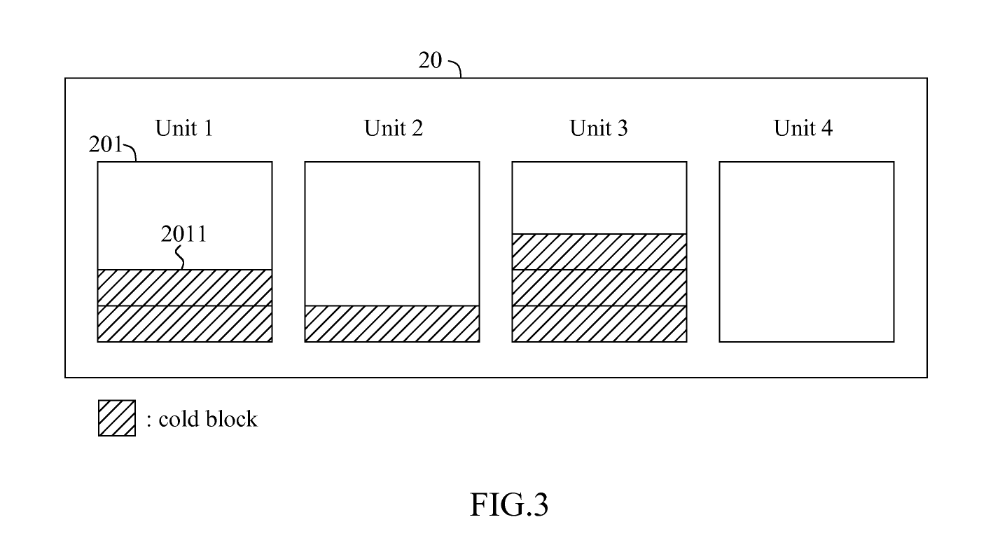

According to one aspect of the embodiment, the memory controller 23 manages and constructs a cold-block table 24 to enhance wear leveling in a global and preemptive manner. As exemplified in FIG. 3, a cold block or blocks 2011 are assigned in at least one storage unit 201 (e.g., unit 1, unit 2, unit 3 or unit 4). The cold block 2011 in the associated storage unit 201 has an erase count (or a value of erase cycles) being less than erase counts of other non-cold blocks (that is, the blocks other than the cold block(s) 2011) in the associated storage unit 201. In other words, in a given storage unit 201, the cold block or blocks 2011 have been subject to fewer erase cycles than the non-cold blocks. Logical addresses and associated physical addresses of the cold blocks 2011 are recorded in the cold-block table 24, thereby building a cold-block pool or group composed of the multiple cold blocks 2011. Moreover, each storage unit 201 is respectively subject to wear leveling scheme such as static wear leveling.

In the embodiment, an amount of the cold blocks 2011 assigned in a given storage unit 201 is determined according to a total erase count of that given storage unit 201 compared with other storage units 201 of the memory 20. Accordingly, more cold blocks 2011 are assigned to a storage unit 201 with a lower total erase count. On the other hand, fewer cold blocks 2011 are assigned to a storage unit 201 with a higher total erase count. Taking the memory 20 shown in FIG. 3 as an example, storage unit 3 has the lowest total erase count, and storage unit 4 has the highest total erase count.

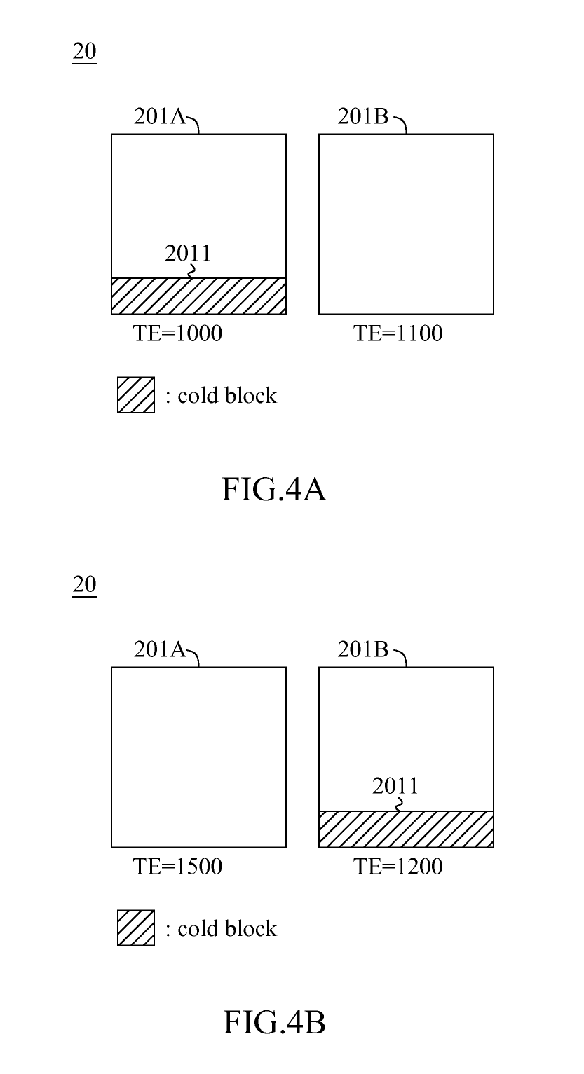

The assignment of the cold blocks 2011 in the memory 20 may be performed dynamically. For example, the assignment of the cold blocks 2011 is updated periodically. Alternatively, the assignment of the cold blocks 2011 may be updated whenever, for example, one cold block 2011 has been filled up. FIG. 4A and FIG. 4B show an example of sequentially assigning a cold block 2011 in a memory 20 composed of two storage units (i.e., a first storage unit 201A and a second storage unit 201B). At first, as shown in FIG. 4A, the cold block 2011 is assigned to the first storage unit 201A as the first storage unit 201A has a total erase count (TE) less than the second storage unit 201B. After the memory 20 has been subject to erase cycles for a period, as shown in FIG. 41B, the cold block 2011 is assigned instead to the second storage unit 201B because of its lower total erase count.

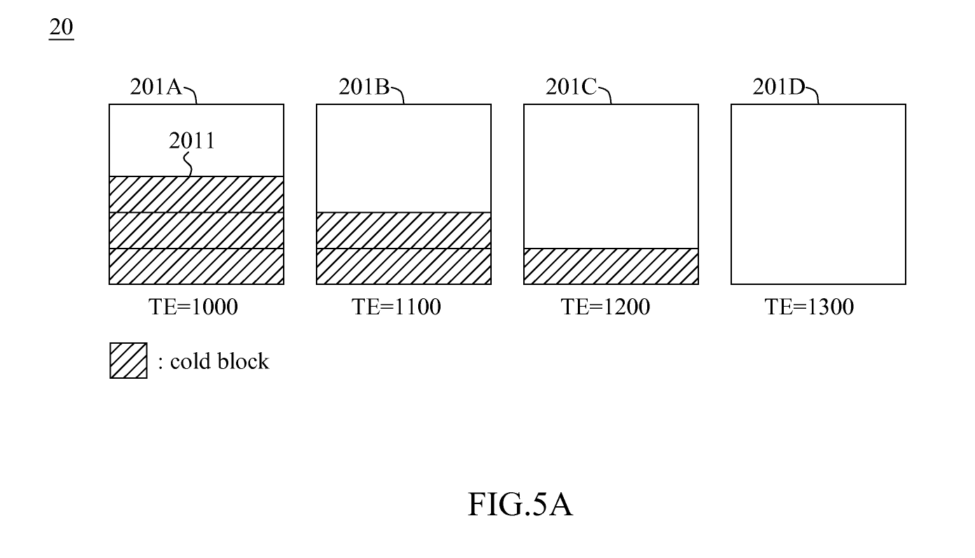

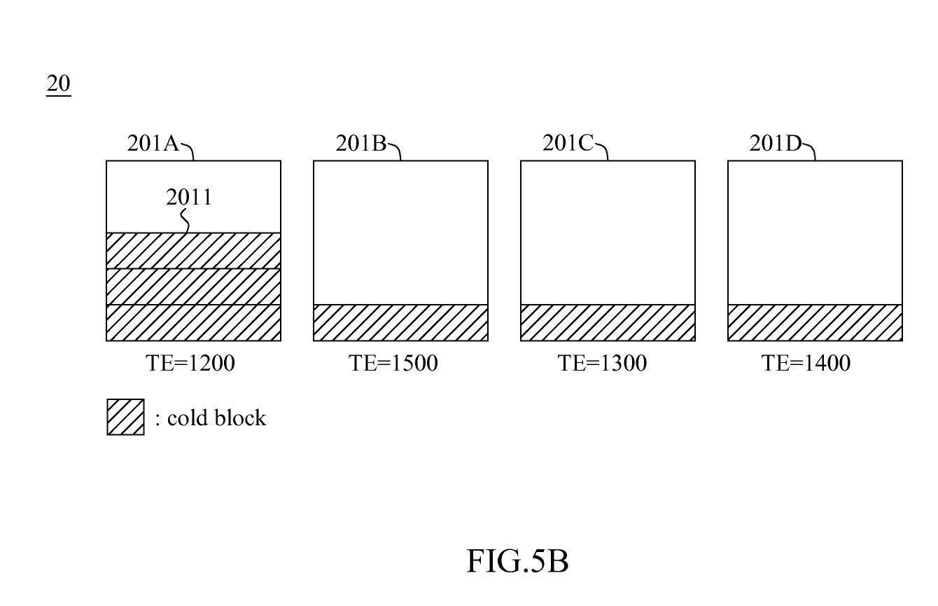

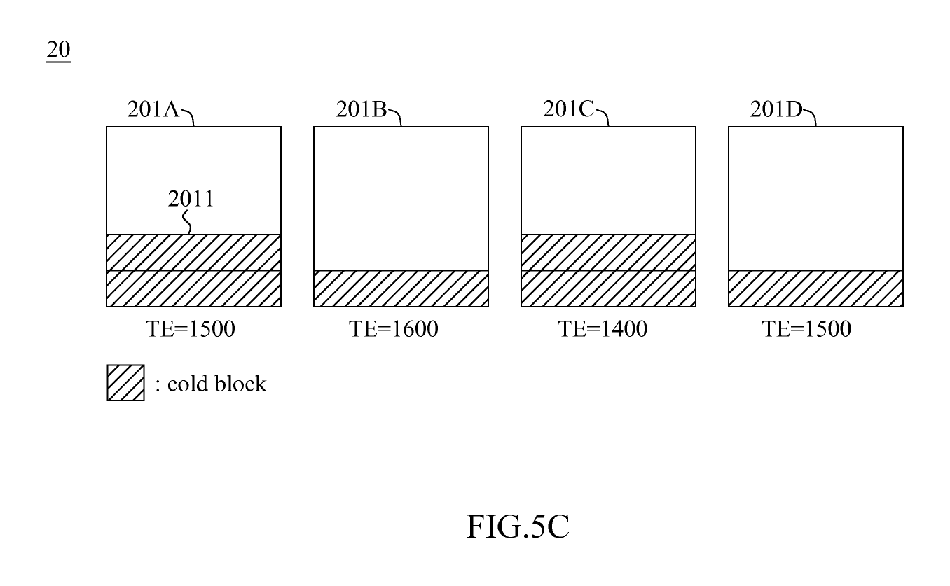

FIG. 5A through FIG. 5C show another example of sequentially assigning six cold blocks 2011 in a memory 20 composed of four storage units (i.e., a first storage unit 201A, a second storage unit 201B, a third storage unit 201C and a fourth storage unit 201D). At first, as shown in FIG. 5A, the six cold blocks 2011 are assigned, as shown, according to the total erase counts (TEs) of the storage units 201A-201D. After one cold block 2011 of the second storage unit 201B has been filled up, as shown in FIG. 5B, a new cold block 2011 is newly assigned to the fourth storage unit 201D. Afterwards, as one cold block 2011 of the first storage unit 201A has been filled up, as shown in FIG. 5C, a new cold block 2011 is newly assigned to the third storage unit 201C.

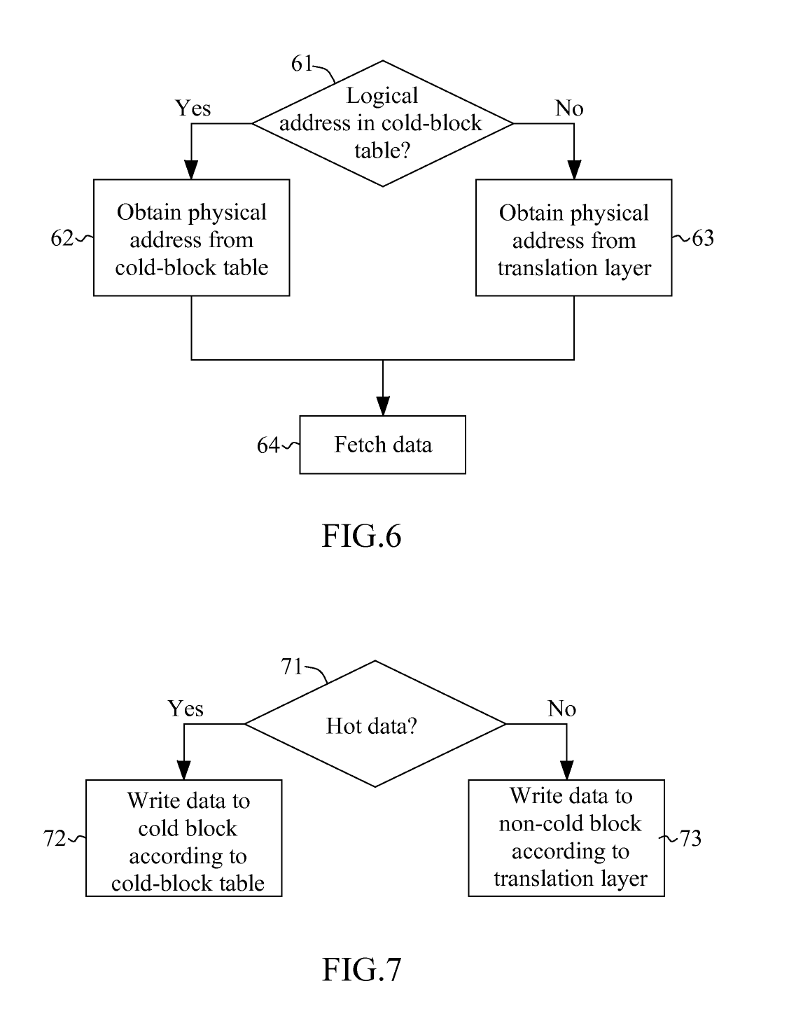

According to the constructed cold-block table 24, accompanied by the translation layer 22, the host 21 may then access the memory 20 in an efficient manner to effectively distribute the erase cycles evenly for prolonging service life of the memory 20. FIG. 6 shows a flow diagram of reading data from the memory 20 to the host 21 according to the embodiment of the present invention. In step 61, a logical address associated with a read command provided by the host 21 is determined whether being in the cold-block table 24. If the determination is positive, a corresponding physical address is obtained from the cold-block table 24 (step 62); otherwise, if the determination is negative, a corresponding physical address is obtained from the translation layer 22 (step 63). In step 64, data are fetched from the memory 20 according to the physical address either from the cold-block table 24 (step 62) or from the translation layer 22 (step 63), and are then forwarded to the host 21.

FIG. 7 shows a flow diagram of writing data from the host 21 to the memory 20 according to the embodiment of the present invention. In step 71, data to be written to the memory 20 are determined whether being hot data. If the data are determined as being hot data, they are written to the cold block 2011 according to the cold-block table 24 (step 72); otherwise, if the data are determined as being not hot data (i.e., cold data), they are written to (the non-cold block of) the memory 20 according to the translation layer 22 (step 73). The definition of “hot” data in the embodiment may adopt conventional practices. For example, the data with a corresponding logical address that has an associated access count being higher than a predetermined value may thus be regarded as hot data. In another example, the data with short length (e.g., less than 4K) may be determined as hot data.

According to the embodiment described above, as the assignment of the cold blocks 201 of the cold-block table 24 is performed by considering the erase counts among the storage units 201 globally, the wear leveling initially performed in the individual storage units 201 may thus be globally enhanced. Further, as hot data are directly written to the cold blocks, rather than being arbitrarily written to the memory and are then wear leveled as in the conventional scheme, the embodiment therefore provides a preemptive scheme to enhance the wear leveling in the memory 20. Moreover, as the cold-block table 24 only records the cold blocks 201, the cold-block table 24 requires only modest amount of storage, rather than enormous storage demanded in some conventional wear leveling mechanisms.

In a further embodiment, data of the cold block 201 is subject to garbage collection or valid data collection to reclaim garbage or memory occupied by objects that are no longer in use. In the embodiment, garbage collection or valid data collection is performed according to address of original (or old) data. For example, as illustrated in FIG. 5C, hot data originally resided in the second storage unit 201B need be relocated into the cold block 2011 of the first storage unit 201A, while the two cold blocks 2011 of the first storage unit 201A have insufficient space or garbage collection is requested. According to the embodiment, data in the cold blocks 2011 of the first storage unit 201A pertinent to the second storage unit 201B will accordingly be relocated back to relevant block in the second storage unit 201B.

Although specific embodiments have been illustrated and described, it will be appreciated by those skilled in the art that various modifications may be made without departing from the scope of the present invention, which is intended to be limited solely by the appended claims.

What is claimed is:

1. A system of wear leveling for a non-volatile memory, comprising:
a plurality of storage units in the non-volatile memory;
a translation layer configured to translate a logical address provided by a host to a physical address of the non-volatile memory; and
a cold-block table configured to assign a cold block or blocks in at least one said storage unit, the cold block in a given storage unit having an erase count being less than erase counts of non-cold blocks in the given storage unit;
wherein the logical addresses and the associated physical addresses of the cold blocks are recorded in the cold-block table, thereby building a cold-block pool composed of the cold blocks.

2. The system of claim 1, wherein the non-volatile memory comprises a flash memory.

3. The system of claim 2, wherein the translation layer comprises a flash translation layer (FTL) for supporting file systems with the flash memory.

4. The system of claim 1, further comprising a memory controller configured to control the translation layer and manage the cold-block table.

5. The system of claim 1, wherein the storage units are further subject to wear leveling scheme, respectively.

6. The system of claim 5, wherein the wear leveling scheme comprises static year leveling.

7. The system of claim 1, wherein an amount of the cold blocks assigned in the given storage unit is determined according to a total erase count of the given storage unit compared with others of the storage units of the non-volatile memory.

8. The system of claim 7, wherein more said cold blocks are assigned to a storage unit with a lower total erase count, and fewer said cold blocks are assigned to a storage unit with a higher total erase count.

9. The system of claim 1, wherein the assignment of the cold blocks in the non-volatile memory is updated periodically, or whenever one of the cold blocks has been filled up.

10. The system of claim 1, wherein data of the cold block is subject to garbage collection or valid data collection that is performed according to address of original data in an original storage unit.

11. A method of wear leveling for a non-volatile memory, comprising:
providing a plurality of storage units in the non-volatile memory;
configuring a translation layer to translate a logical address provided by a host to a physical address of the non-volatile memory; and
configuring a cold-block table to assign a cold block or blocks in at least one said storage unit, the cold block in a given storage unit having an erase count being less than erase counts of non-cold blocks in the given storage unit;
wherein the logical addresses and the associated physical addresses of the cold blocks are recorded in the cold-block table, thereby building a cold-block pool composed of the cold blocks.

12. The method of claim 11, wherein the translation layer comprises a flash translation layer (FTL) for supporting file systems with a flash memory.

13. The method of claim 11, further comprising a step of subjecting the storage units to wear leveling scheme, respectively.

14. The method of claim 13, wherein the wear leveling scheme comprises static year leveling.

15. The method of claim 11, wherein an amount of the cold blocks assigned in the given storage unit is determined according to a total erase count of the given storage unit compared with others of the storage units of the non-volatile memory.

16. The method of claim 15, wherein more said cold blocks are assigned to a storage unit with a lower total erase count, and fewer said cold blocks are assigned to a storage unit with a higher total erase count.

17. The method of claim 11, wherein, the assignment of the cold blocks in the non-volatile memory is updated periodically, or whenever one of the cold blocks has been filled up.

18. The method of claim 11, further comprising a step of subjecting data of the cold block to garbage collection or valid data collection that is performed according to address of original data in an original storage unit.

19. The method of claim 11, further comprising the following steps of reading data from the non-volatile memory to the host:
determining whether a logical address associated with a read command provided by the host is in the cold-block table;
obtaining a corresponding physical address from the cold-block table if the logical address is determined to be in the cold-block table;
obtaining a corresponding physical address from the translation layer if the logical address is determined to be not in the cold-block table; and
fetching data from the non-volatile memory according to the physical address either from the cold-block table or from the translation layer, and then forwarding the data to the host.

20. The method of claim 11, further comprising the following steps of writing data from the host to the non-volatile memory:
determining whether the data are hot data;
writing the data to the cold block according to the cold-block table if the data are determined to be hot data; and
writing the data to the non-cold block according to the translation layer if the data are determined to be not hot data.
